(19) United States
(12) Patent Application Publication
(10) Pub. No.: US 2022/0162350 A1
(43) Pub. Date: May 26, 2022

(54) COMPOSITIONS FOR HIGH STABILIZATION OF EMULSIONS

(71) Applicant: RHODIA OPERATIONS, Aubervilliers (FR)

(72) Inventors: Helène MARTIN, Chatilon (FR); Patrick MOREAU, Saint- Denis (FR)

(21) Appl. No.: 17/433,030

(22) PCT Filed: Feb. 14, 2020
(86) PCT No.: PCT/EP2020/053942

§ 371 Date: Aug. 23, 2021

(30) Foreign Application Priority Data
Feb. 28, 2019 (EP) 19159925.7

(51) Int. Cl. C08F 2/24; C08F 293/00

(52) U.S. Cl. CPC C08F 2/24; C08F 2438/03; C08F 293/005

(57) ABSTRACT

The instant invention concerns compositions suitable for stabilizing emulsions, which comprise a mixture of:—at least an alkanolamide emulsifier; and—a block copolymer comprising:—a hydrophilic block comprising units deriving from a mono-alpha-ethylenically-unsaturated monomers; and—a block B preferably deriving from a mono-alpha-ethylenically-unsaturated monomers

The instant invention relates to the field of stabilization of emulsions, especially the stabilization of inverse emulsions, namely of water-in-oil emulsions (also referred as “w/o emulsions”) comprising droplets of an aqueous phase dispersed within an oily phase.

More specifically, the invention relates to emulsifier compositions that are especially suitable for stabilizing inverse emulsions comprising high molecular weight polyelectrolytes (typically synthetic hydrosoluble homo- or co-polymers) in their dispersed aqueous phase, especially by minimizing gel formation under shearing and during the storage.

The invention is i.a. directed to inverse emulsions comprising polyacrylamides (PAM) in their dispersed aqueous phase. As used in the instant description the term “polyacrylamide” or “PAM” refers to an homo- or co-polymer including -or consisting in-acrylamide units. One of the technologies used to obtain PAM, is the polymerization in inverse emulsion. The invention is notably directed to inverse emulsion obtained in this scope and to the enhancement of their storage stability and their stability under shearing.

Emulsions are compositions, usually liquid or gelled, comprising at least two phases which are not miscible, one phase being dispersed in the form or droplets in the other. Using surfactants allows obtaining the dispersion of one of the phases in the other. Thus, emulsions are usually obtained by mixing the phases and surfactants.

As used herein, the term “emulsion” preferably refers to such a dispersed mixture with one phase dispersed in another, said mixture being thermodynamically less stable than a phase-separated system, which excludes the case of so-called “microemulsions” which are thermodynamically more stable than the phase-separated system.

Stabilizing emulsions (i.e. avoiding demixtion) is an issue to be addressed for many purposes. In consumer goods, there is a need for emulsions having a long lifetime, as well for it to keep its properties, as for it to keep a good aspect. In the industry, emulsions are often required to remain stable at least as long as needed to prepare a product, or as long as it is stored.

Emulsifiers and emulsifier compositions known for preparing inverse emulsions do not systematically lead to a proper stabilization of the obtained emulsion, especially in inverse emulsion containing polyelectrolytes such as PAM.

For example, good emulsifiers are known, which allow the formation of droplets of dispersed phase having low particle size (namely a good emulsification of the dispersed phase in the continuous phase), but with a limited (or even very limited) stability upon storage, often together with the formation of so-called “flocs”, namely aggregation of droplets of the dispersed phase, with or without coalescence (the droplets may typically form aggregates similar to bunch of grapes, with optional inter-droplets aggregation). This is the case e.g. with emulsifiers such as sorbitan monooleate (herein referred as “SMO”) when used for preparing inverse emulsions.

One aim of the present invention is to provide an emulsifier composition that both:

(i) allows a good emulsification, with droplets of dispersed phase having low particle size; and

(ii) imparts a very good stability of the obtained emulsion,

especially when used for preparing an inverse emulsion comprising a high molecular weight polyelectrolyte in the dispersed aqueous phase.

To this end, it is proposed according to the present invention to make use of a specific emulsifier package, comprising (1) an emulsifier including an alkanolamides; and (2) a specific block copolymer.

More precisely, according to a first aspect, one subject-matter of the present invention is a composition, herein referred as “composition C”, comprising a mixture of:
at least an alkanolamide emulsifier (optionally together with other emulsifiers); and
a block copolymer comprising:
   a block A which is a hydrophilic block comprising units deriving from a mono-alpha-ethylenically-unsaturated monomers;
and
   a block B which is a hydrophobic block, preferably deriving from a mono-alpha-ethylenically-unsaturated monomers.

In most cases, it is highly preferable for the block copolymer of composition C not to be a copolymer having a lower critical solubility temperature (LCST). According to preferred embodiment, the block A is distinct from a block having a lower critical solubility temperature (LOST). Especially, the copolymer of composition C is advantageously distinct from the heat sensitive polymers described e.g. in the patent application US 2011/0130321.

According to a second aspect, another subject-matter of the present invention is an emulsion, especially an inverse emulsion, which comprises the composition C as defined above. In this connection, the invention is especially directed to inverse emulsions containing PAM homo- or co-polymers in their dispersed aqueous phase.

According to a more specific aspect, one other subject-matter of the present is the use of the composition C as defined above for stabilizing an emulsion, especially an inverse emulsion, typically an inverse emulsion containing a PAM homo- or co-polymers in its dispersed aqueous phase.

In the composition C useful according to the invention, the block copolymer acts together with the emulsifier containing the alkanolamide, and the mixture of the two compounds allows a good emulsification and a good stability of the obtained emulsion, especially in the case of inverse emulsions. Most of the time, the copolymer provides, as such, an emulsifier effect, but the mixture exhibit emulsification and stability effects that are more than the simple addition of the effect of each of the ingredients taken alone.

The composition C as used according to the invention allows to obtain a very low particle size in the emulsion and a good stability storage (typically, the particle size remains low even after a two-month storage at 50° C.), generally without any (or only very few) formation of flocs.

Preferably, the ratio copolymer/emulsifier, corresponding to the quotient of the total mass of copolymer contained in composition C, to the total mass of the emulsifier including alkanolamide in composition C is between 1% and 40%, this ratio being preferably of at most 30%, for example of at most 20%. Typically, the ratio copolymer/emulsifier may advantageously be comprised between 2% and 20%, for example between 2.5% and 10%.

Preferably, the ratio copolymer/alkanolamide, corresponding to the quotient of the total mass of copolymer contained in composition C, to the total mass of the alkanolamide emulsifier contained in composition C is between 1% and 45%, typically between 1% and 40%, this ratio being preferably of at most 30%, for example of at most 20%. Typically, the ratio copolymer/alkanolamide may advantageously be comprised between 2% and 20%, for example between 2.5% and 10%. The block copolymer and the alkanolamide emulsifier cooperate especially good i.a. with such mass ratios.

Typically, the composition C is used in an emulsion at a content of between 0.5% and 5%, for example 1% and 4% in mass, based on the total mass of the emulsion containing the composition C.

For example, an emulsion may be stabilized according to the invention by introducing in the emulsion:
from 1% to 2% of an alkanolamide emulsifier; and
from 0.001 to 0.5%, for example from 0.1% to 0.4% of copolymer,
the percentages being in mass, based on the total mass of the emulsion containing the composition C.

Specific features and possible embodiments will now been described in more details.

### The Alkanolamide Emulsifier

The alkanolamide emulsifier present in the composition C of the invention is a compound bearing both an amide and hydroxyl functional groups. This alkanolamide emulsifier is typically a compound having the Formula (I) below:

R¹C(═O)—N[—(R²O)ₓH)][—(R³O)_{y}H] (I)

wherein:
R¹ is an hydrocarbon chain bearing typically from 5 to 24 carbon atoms, preferably at least 10 and typically at least 16
each of R² and R³, which are the same or not, are hydrocarbon chain bearing from 2 to 4 carbon atoms
each of x and y, which are the same or not, are of between 1 and 5.

Alkanolamide emulsifiers suitable in composition C especially include compounds of formula (I) wherein x=y=1, namely compounds having the Formula (Ia) below:

R¹—C(═O)—N(R²OH)(R³OH) (Ia)

wherein R¹, R² and R³ have the meanings given above.

According to a specific embodiment, R² and R³ are the same. Alkanolamide emulsifiers suitable in this connection include e.g. compounds of formula (Ib) below:

R¹—C(═O)—N(R²OH)(R³OH) (Ib)

wherein R¹ , R² and R³ have the meanings given above, R² and R³ being typically the same.

Alternatively, partially esterified alkanolamides of formula (I), (Ia) and (Ib) may be used, typically alkanolamides of formula (I), (Ia) and (Ib) wherein one of the two terminal —OH group (carried by either the —(R²O)ₓH group or the [—(R³O)_{y}H group) is esterified in the form of a —(R²O)ₓR⁴ group or —(R³O)_{y} R⁴ group, wherein R⁴ is a hydrocarbon chain bearing from 2 to 4 carbon atoms, when the other terminal —OH group (respectively carried by either the [—(R³O)_{y}H group -(or the R²O)ₓH group) is not esterified.

Suitable commercial alkanolamide emulsifier useful according to the instant invention include notably alkyl and alkenyl diethanolamides such as Mackamide®WS 1 or Mackamide® MO (oleyl diethanolamides), or Mackamide® S (soy diethanolamide) available from the Solvay company. According to a specific embodiment, the alkanolamide is Mackamide®WS 1.

Another suitable alkanolamide emulsifier is a partially-esterified N,N-alkanol fatty amide surfactant called Witcamide 511, which is commercially available from the Akzo Company. This surfactant is described in the literature as being approximately 50 percent, by weight, unesterified N,N-diethanol fatty amide, approximately 40 percent, by weight, monoesterified N,N-diethanol fatty amide and some quantity of diesterified material, wherein the fatty groups on the emulsifier chain are approximately 64 percent oleyl, 33 percent linoleic and 3 percent palmetyl.

### The Block Copolymer

Typically, the block copolymer present in the composition C of the invention is selected from:
(block A)-(block B) di-block copolymers;
(block A)-(block B)-(block A) tri-block copolymers; and
(block B)-(block A)-(block B) tri-block copolymers.

According to a preferred embodiment, the block copolymer is a (block A)-(block B) di-block copolymer.

The block copolymer is typically a linear block copolymer. By “linear” it is meant that the blocks arrangement is linear. However, in specific embodiments, a block may be a block having a comb polymer structure, that is comprising repetitive units comprising a polymeric moiety (macromonomers).

A block is usually defined by repeating units it comprises. A block may be defined by naming a polymer, or by naming monomers it is derived from. In the present specification, a unit deriving from a monomer is understood as a unit that may be directly obtained from the said monomer by polymerizing. Thus, a unit deriving from an ester of acrylic or methacrylic acid does not encompass a unit of formula —CH—CH(COOH)— or —CH—C(CH₃)(COOH)—, obtained for example by polymerizing an ester of acrylic or methacrylic acid and then hydrolyzing. But a unit deriving from acrylic acid or methacrylic acid encompasses for example a unit obtained by polymerizing a monomer and then reacting (for example hydrolyzing) to obtain units of formula —CH—CH(COOH)— or —CH—C(CH₃)(COOH)—.

A block may be a copolymer, comprising several kind of repeating units, deriving from several monomers. Hence, block A and block B are different polymers, deriving from different monomers, but they may comprise some common repeating units (copolymers). Block A and Block B preferably do not comprise more than 50% of a common repeating unit (derived from the same monomer).

Block A is hydrophilic and block B is hydrophobic. Hydrophilic or hydrophobic properties of a block refer to the property said block would have without the other block(s), that is the property of a polymer consisting of the same repeating units than said block, having the same molecular weight. By hydrophilic block, polymer or copolymer, it is meant that the block, polymer or copolymer does not phase separate macroscopically in water at a concentration from 0.01% and 10% by weight, at a temperature from 20° C. to 30° C. By hydrophobic block, polymer or copolymer, it is meant that the block, polymer or copolymer does phase separate macroscopically in the same conditions.

It is further mentioned that the block copolymer may be soluble in water, ethanol, and/or in a hydrophobic compound. In a preferred embodiment, the block copolymer is soluble in water, ethanol or in a mixture of water and ethanol. The block copolymer may be introduced in the emulsion, or in the mixture of the compounds comprised in the emulsion, in a solid form, or in a solution form. In a preferred embodiment it in introduced as a water, ethanol, or water/ethanol solution.

Preferably, block B comprises repeating units deriving from monomers selected from the group consisting in:
dialkylsiloxane, such as dimethyl siloxane,
alkylesters of an alpha-ethylenically-unsaturated, preferably mono-alpha-ethylenically-unsaturated, monocarboxylic acid, such as methylacrylate, ethylacrylate, n-propylacrylate, n-butylacrylate, methylmethacrylate, ethylmethacrylate, n-propylmethacrylate, n-butylmethacrylate, and 2-ethyl-hexyl acrylate, 2-ethyl-hexyl methacrylate, isooctyl acrylate, isooctyl methacrylate, lauryl acrylate, lauryl methacrylate,
vinyl versatate,
acrylonitrile,
vinyl nitriles, comprising from 3 to 12 carbon atoms,
vinylamine amides, and
vinylaromatic compounds such as styrene.

An especially suitable block B according to the invention comprises repeating units deriving from alkylesters of an alpha-ethylenically-unsaturated, preferably mono-alpha-ethylenically-unsaturated, monocarboxylic acid, for example 2-ethyl-hexyl acrylate.

On the other hand, block A preferably comprises repeating units deriving from monomers selected from the group consisting of:
vinyl alcohol,
N-vinyl pyrrolidone,
(meth)acrylamide compounds such as, for example acrylamide, methacrylamide, N,N-Dimethyl acrylamide, or alternatively N-hydroxyethylacrylamide and/or N-hydroxymethylacrylamide-polyethylene oxide (meth)acrylate (i.e. polyethoxylated (meth)acrylic acid),
hydroxyalkylesters of alpha-ethylenically-unsaturated, preferably mono-alpha-ethylenically-unsaturated, monocarboxylic acids, such as 2-hydroxyethylacrylate,
hydroxyalkylamides of alpha-ethylenically-unsaturated, preferably mono-alpha-ethylenically-unsaturated, monocarboxylic acids,
dimethylaminoethyl (meth)acrylate, dimethylaminopropyl (meth)acrylate, ditertiobutylaminoethyl (meth)acrylate, dimethylaminomethyl (meth)acrylamide, dimethylaminopropyl (meth)acrylamide;
ethylenimine, vinylamine, 2-vinylpyridine, 4-vinylpyridine;
trimethylammonium ethyl (meth)acrylate chloride, trimethylammonium ethyl (meth)acrylate methyl sulphate, dimethylammonium ethyl (meth)acrylate benzyl chloride, 4-benzoylbenzyl dimethylammonium ethyl acrylate chloride, trimethyl ammonium ethyl (meth)acrylamido (also called 2-(acryloxy)ethyltrimethylammonium, TMAEAMS) chloride, trimethylammonium ethyl (meth)acrylate (also called 2-(acryloxy)ethyltrimethylammonium, TMAEAMS) methyl sulphate, trimethyl ammonium propyl (meth)acrylamido chloride, vinylbenzyl trimethyl ammonium chloride,
diallyldimethyl ammonium chloride,
alpha-ethylenically-unsaturated, preferably mono-alpha-ethylenically-unsaturated, monomers comprising a phosphate or phosphonate group,
alpha-ethylenically-unsaturated, preferably mono-alpha-ethylenically-unsaturated, monocarboxylic acids, such as acrylic acid, methacrylic acid
monoalkylesters of alpha-ethylenically-unsaturated, preferably mono-alpha-ethylenically-unsaturated, dicarboxylic acids,
monoalkylamides of alpha-ethylenically-unsaturated, preferably mono-alpha-ethylenically-unsaturated, dicarboxylic acids, and
alpha-ethylenically-unsaturated, preferably mono-alpha-ethylenically-unsaturated, compounds comprising a sulphonic acid group, and salts of alpha-ethylenically-unsaturated, preferably mono-alpha-ethylenically-unsaturated, compounds comprising a sulphonic acid group, such as vinyl sulphonic acid, salts of vinyl sulfonic acid, vinylbenzene sulphonic acid, salts of vinylbenzene sulphonic acid, alpha-acrylamidomethylpropanesulphonic acid, salts of alpha-acrylamidomethylpropanesulphonic acid 2-sulphoethyl methacrylate, salts of 2-sulphoethyl methacrylate, acrylamido-2-methylpropanesulphonic acid (AMPS), salts of acrylamido-2-methylpropanesulphonic acid, and styrenesulfonate (SS).

An especially suitable block A according to the invention comprises repeating units deriving from N-vinyl pyrrolidone, acrylamide and/or N,N-Dimethylacrylamide.

According to a specific embodiment, the copolymer present in the composition C is a diblock copolymer comprising a block A comprising repeating units deriving from N-vinyl pyrrolidone; and a block B that comprises repeating units deriving from 2-ethyl-hexyl acrylate.

While block B is usually a neutral block, block A might be discriminated as regard to its electrical behavior or nature. It means that block A may be a neutral block, or a polyionic block (a polyanionic block, or a polycationic block). It is further mentioned the electrical behavior or nature (neutral, polyanionic or polycationic) may depend on the pH of the emulsion. By polyionic it is meant that the block comprises ionic (anionic or cationic) repetitive units whatever the pH, or that the block comprises repetitive units that may be neutral or ionic (anionic or cationic) depending on the pH of the emulsion (the units are potentially ionic). A unit that may be neutral or ionic (anionic or cationic), depending on the pH of the composition, will be thereafter referred as an ionic unit (anionic or cationic), or as a unit deriving from an ionic monomer (anionic or cationic), whatever it is in a neutral form or in an ionic form (anionic or cationic).

When block A is a polyionic block, it comprises ionic units (respectively: cationic units for polycationic blocks; anionic units for polyanionic blocks; or even mixtures of cationic and anionic units) optionally together with additional neutral units.

Examples of polycationic blocks are blocks comprise units deriving from cationic monomers such as:
aminoalkyl (meth)acrylates, aminoalkyl (meth)acrylamides,
monomers, including particularly (meth)acrylates, and (meth)acrylamides derivatives, comprising at least one secondary, tertiary or quaternary amine function, or a heterocyclic group containing a nitrogen atom, vinylamine or ethylenimine;
diallyldialkyl ammonium salts;
their mixtures, their salts, and macromonomers deriving from therefrom.

Examples of cationic monomers include:
dimethylaminoethyl (meth)acrylate, dimethylaminopropyl (meth)acrylate, ditertiobutylaminoethyl (meth)acrylate, dimethylaminomethyl (meth)acrylamide, dimethylaminopropyl (meth)acrylamide;
ethylenimine, vinylamine, 2-vinylpyridine, 4-vinylpyridine;
trimethylammonium ethyl (meth)acrylate chloride, trimethylammonium ethyl (meth)acrylate methyl sulphate, dimethylammonium ethyl (meth)acrylate benzyl chloride, 4-benzoylbenzyl dimethylammonium ethyl acrylate chloride, trimethyl ammonium ethyl (meth)acrylamido (also called 2-(acryloxy)ethyltrimethylammonium, TMAEAMS) chloride, trimethylammonium ethyl (meth)acrylate (also called 2-(acryloxy)ethyltrimethylammonium, TMAEAMS) methyl sulphate, trimethyl ammonium propyl (meth)acrylamido chloride, vinylbenzyl trimethyl ammonium chloride,
diallyldimethyl ammonium chloride,
their mixtures, and macromonomers deriving therefrom.

Examples of anionic blocks are blocks comprising units deriving from anionic monomers selected from the group consisting of:
alpha-ethylenically-unsaturated, preferably mono-alpha-ethylenically-unsaturated, monomers comprising a phosphate or phosphonate group,
alpha-ethylenically-unsaturated, preferably mono-alpha-ethylenically-unsaturated, monocarboxylic acids,
monoalkylesters of alpha-ethylenically-unsaturated, preferably mono-alpha-ethylenically-unsaturated, dicarboxylic acids,
monoalkylamides of alpha-ethylenically-unsaturated, preferably mono-alpha-ethylenically-unsaturated, dicarboxylic acids,
alpha-ethylenically-unsaturated, preferably mono-alpha-ethylenically-unsaturated, compounds comprising a sulphonic acid group, and salts of alpha-ethylenically-unsaturated compounds comprising a sulphonic acid group.

Preferred anionic blocks include blocks comprising deriving from at least one anionic monomer selected from the group consisting of:
acrylic acid, methacrylic acid,
vinyl sulphonic acid, salts of vinyl sulfonic acid,
vinylbenzene sulphonic acid, salts of vinylbenzene sulphonic acid,
alpha-acrylamidomethylpropanesulphonic acid, salts of alpha-acrylamidomethylpropanesulphonic acid
2-sulphoethyl methacrylate, salts of 2-sulphoethyl methacrylate,
acrylamido-2-methylpropanesulphonic acid (AMPS), salts of acrylamido-2-methylpropanesulphonic acid, and
styrenesulfonate (SS).

Examples of neutral blocks (block A or block B) are blocks comprising units deriving from at least one monomer selected from the group consisting of:
acrylamide, methacrylamide, N,N-Dimethylacrylamide
amides of alpha-ethylenically-unsaturated, preferably mono-alpha-ethylenically-unsaturated, monocarboxylic acids,
esters of an alpha-ethylenically-unsaturated, preferably mono-alpha-ethylenically-unsaturated, monocarboxylic acid, for example alkyl esters such as such as methylacrylate, ethylacrylate, n-propylacrylate, n-butylacrylate, methylmethacrylate, ethylmethacrylate, n-propylmethacrylate, n-butylmethacrylate, 2-ethyl-hexyl acrylate, or hydroxyalkyl esters such as 2-hydroxyethylacrylate,
polyethylene and/or polyporpylene oxide (meth)acrylates (i.e. polyethoxylated and/or polypropoxylated (meth)acrylic acid),
vinyl alcohol,
vinyl pyrrolidone,
vinyl acetate, vinyl Versatate,
vinyl nitriles, preferably comprising from 3 to 12 carbon atoms,
acrylonitrile,
vinylamine amides,
vinyl aromatic compounds, such as styrene, and
mixtures thereof.

There are several methods for making block copolymers. Some methods for making such copolymers are provided below.

It is possible for example to use anionic polymerization with sequential addition of 2 monomers as described for example by Schmolka, J. Am. Oil Chem. Soc. 1977, 54, 110; or alternatively Wilczek-Veraet et al., Macromolecules 1996, 29, 4036. Another method which can be used consists in initiating the polymerization of a block polymer at each of the ends of another block polymer as described for example by Katayose and Kataoka, Proc. Intern. Symp. Control. Rel. Bioact. Materials, 1996, 23, 899.

In the context of the present invention, it is recommended to use living or controlled polymerization as defined by Quirk and Lee (Polymer International 27, 359 (1992)). Indeed, this particular method makes it possible to prepare polymers with a narrow dispersity and in which the length and the composition of the blocks are controlled by the stoichiometry and the degree of conversion. In the context of this type of polymerization, there are more particularly recommended the copolymers which can be obtained by any so-called living or controlled polymerization method such as, for example:
free-radical polymerization controlled by xanthates according to the teaching of Application WO 98/58974 and Patent U.S. Pat. No. 6,153,705,
free-radical polymerization controlled by dithioesters according to the teaching of Application WO 98/01478,
free-radical polymerization controlled by dithioesters according to the teaching of Application WO 99/35178,
free-radical polymerization controlled by dithiocarbamates according to the teaching of Application WO 99/35177,
free-polymerization using nitroxide precursors according to the teaching of Application WO 99/03894,
free-radical polymerization controlled by dithiocarbamates according to the teaching of Application WO 99/31144,
free-radical polymerization controlled by dithiocarbazates according to the teaching of Application WO 02/26836,
free-radical polymerization controlled by halogenated Xanthates according to the teaching of Application WO 00/75207 and U.S. application Ser. No. 09/980,387,
free-radical polymerization controlled by dithiophosphoroesters according to the teaching of Application WO 02/10223,
free-radical polymerization controlled by a transfer agent in the presence of a disulphur compound according to the teaching of Application WO 02/22688,
atom transfer radical polymerization (ATRP) according to the teaching of Application WO 96/30421,
free-radical polymerization controlled by iniferters according to the teaching of Otu et al., Makromol. Chem. Rapid. Commun., 3, 127 (1982),
free-radical polymerization controlled by degenerative transfer of iodine according to the teaching of Tatemoto et al., Jap. 50, 127, 991 (1975), Daikin Kogyo Co Ltd Japan, and Matyjaszewski et al., Macromolecules, 28, 2093 (1995),
group transfer polymerization according to the teaching of Webster O. W., “Group Transfer Polymerization”, p. 580-588, in the “Encyclopedia of Polymer Science and Engineering”, Vol. 7, edited by H. F. Mark, N. M. Bikales, C. G. Overberger and G. Menges, Wiley Interscience, New York, 1987,
radical polymerization controlled by tetraphenylethane derivatives (D. Braun et al., Macromol. Symp., 111, 63 (1996)),
radical polymerization controlled by organocobalt complexes (Wayland et al., J. Am. Chem. Soc., 116, 7973 (1994)).

Preferred processes are sequenced living free-radical polymerization processes, involving the use of a transfer agent. Preferred transfer agents are agents comprising a group of formula —S—C(S)—Y—, —S—C(S)—S—, or —S—P(S)—Y—, or —S—P(S)—S—, wherein Y is an atom different from sulfur, such as an oxygen atom, a nitrogen atom, and a carbon atom.

They include dithioester groups, thioether-thione groups, dithiocarbamate groups, dithiphosphoroesters, dithiocarbazates, and xanthate groups. Examples of groups comprised in preferred transfer agents include groups of formula —S—C(S)—NR—NR′2, —S—C(S)—NR-N═CR′2, —S—C(S)—O—R, —S—C(S)—CR═CR′2, and —S—C(S)—X, wherein R and R′ are or identical or different hydrogen atoms, or organic groups such as hydrocarbyl groups, optionally substituted, optionally comprising heteroatoms, and X is an halogen atom. A preferred polymerization process is a living radical polymerization using xanthates.

Copolymers obtained by a living or controlled free-radical polymerization process may comprise at least one transfer agent group at an end of the polymer chain. In particular embodiment such a group is removed or deactivated.

A “living” or “controlled” radical polymerization process used to make the block copolymers comprises the steps of:
a) reacting a mono-alpha-ethylenically-unsaturated monomer, at least a free radicals source compound, and a transfer agent, to obtain a first block, the transfer agent being bounded to said first block,
b1) reacting the first block, another mono-alpha-ethylenically-unsaturated monomer, and, optionally, at least a radical source compound, to obtain a di-block copolymer,
b2) optionally, repeating n times (n being equal to or greater than 0) step b1) to obtain a (n-2)-block copolymer, and then
c) optionally, reacting the transfer agent with means to render it inactive.

For example, a “living” or “controlled” radical polymerization process used to make the di-block copolymers comprises the steps of:
a) reacting a mono-alpha-ethylenically-unsaturated monomer, at least a free radicals source compound, and a transfer agent, to obtain a first block, the transfer agent being bounded to said first block,
b) reacting the first block, another mono-alpha-ethylenically-unsaturated monomer, and, optionally, at least a radical source compound, to obtain a di-block copolymer, and then
c) optionally, reacting the transfer agent with means to render it inactive.

During step a), a first block of the polymer is synthesized. During step b), b1), or b2), another block of the polymer is synthesized.

Examples of transfer agents are transfer agents of the following formula (I):

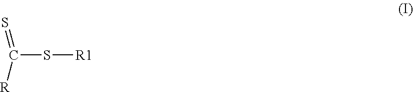

wherein:
R represents an R2O—, R2R′2N— or R3— group, R2 and R′2, which are identical or different, representing (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted, R3 representing H, Cl, an alkyl, aryl, alkene or alkyne group, an optionally substituted, saturated or unsaturated (hetero)cycle, an alkylthio, alkoxycarbonyl, aryloxycarbonyl, carboxyl, acyloxy, carbamoyl, cyano, dialkyl- or diarylphosphonato, or dialkyl- or diarylphosphinato group, or a polymer chain,
R1 represents (i) an optionally substituted alkyl, acyl, aryl, alkene or alkyne group or (ii) a carbonaceous ring which is saturated or unsaturated and which is optionally substituted or aromatic or (iii) an optionally substituted, saturated or unsaturated heterocycle or a polymer chain, and
The R1, R2, R′2 and R3 groups can be substituted by substituted phenyl or alkyl groups, substituted aromatic groups or the following groups: oxo, alkoxycarbonyl or aryloxycarbonyl (—COOR), carboxyl (—COOH), acyloxy (—O2CR), carbamoyl (—CONR2), cyano (—CN), alkylcarbonyl, alkylarylcarbonyl, arylcarbonyl, arylalkylcarbonyl, isocyanato, phthalimido, maleimido, succinimido, amidino, guanidino, hydroxyl (—OH), amino (—NR2), halogen, allyl, epoxy, alkoxy (—OR), S-alkyl, S-aryl or silyl, groups exhibiting a hydrophilic or ionic nature, such as alkaline salts of carboxylic acids or alkaline salts of sulphonic acid, poly(alkylene oxide) (PEO, PPO) chains, or cationic substituents (quaternary ammonium salts), R representing an alkyl or aryl group.

Preferably, the transfer agent of formula (I) is a dithiocarbonate chosen from the compounds of following formulae (IA), (IB) and (IC):

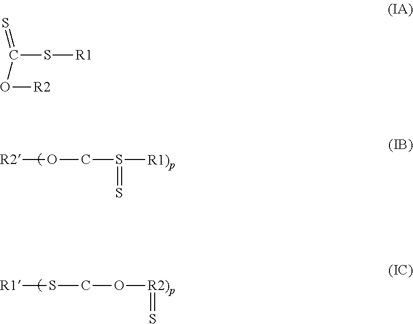

wherein:
R2 and R2′ represent (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted,
R1 and R1′ represent (i) an optionally substituted alkyl, acyl, aryl, alkene or alkyne group or (ii) a carbonaceous ring which is saturated or unsaturated and which is optionally substituted or aromatic or (iii) an optionally substituted, saturated or unsaturated heterocycle or a polymer chain, and
p is between 2 and 10.

The average molecular weight of the block copolymer is preferably comprised between 1000 and 100000 g/mol. It is more preferably comprised between 2000 and 20000 g/mol. Within these ranges, the weight ratio of each block may vary. It is however preferred that each block has a molecular weight above 500 g/mol, and preferably above 1000 g/mol. Within these ranges, the weight ratio of block A in the copolymer is preferably greater than or equal to 50%. It is preferably comprised between 90% and 70%.

According to an interesting embodiment corresponding to the appended examples, the block copolymer present in the composition C of the invention is Rhodibloc® RS available from the Solvay company.

### The Emulsions Stabilized According to the Invention

An emulsion comprising the composition C of the invention comprises an aqueous phase, and a hydrophobic phase, one being dispersed in another, in the form of droplets. Typically, the aqueous phase is dispersed in the hydrophobic phase.

In addition to composition C, the emulsion may contain an additional co-emulsifier. In that case, the co-emulsifier may be any usual emulsifier, such as, for example, sorbitan monooleate, ethoxylated sorbitan monooleate, and/or ethoxylated alcohol. More generally, the emulsion may contain an additional co-emulsifier, having preferably e a HL B of lower than or equal to 10, Iselected from the group consisting of sorbitan esters, ethoxylated alcohols, ethoxylated alkyl phenols, and ethoxylated castor oils. Examples of such surfactants include: sorbitan trioleate, sorbitan tristearate, polyoxyethylene sorbitol hexastearate, lactylated mono- and diglycerides of fat-forming fatty acids, ethylene glycol fatty acid ester, mono- and diglycerides of fat-forming fatty acids, mono- and di glycerides from the glycerolysis of edible fats, propylene glycol fatty acid ester, propylene glycol monostearate, ethylene glycol fatty acid ester, sorbitan sesquioleate, polyoxyethylene sorbitol 4.5 oleate, glycerol mono stearate, sorbitan partial fatty esters, high-molecular-weight fatty amine blend, diethylene glycol fatty acid ester polyoxyethylene stearyl ether, polyoxyethylene oleyl ether, polyoxyethylene sorbitol beeswax derivative, polyoxyethylene cetyl ether, diethylene glycol monolaurate, sorbitan monopalmitate, sorbitan monooleate polyoxyethylene ester mixed fatty and resin acids blend, polyoxypropylene mannitol dioleate, polyoxyethylene sorbitol lanolin derivative, sorbitan monolaurate, sorbitan monooleate, U.S. Pat. No. 8,357,724 B2 polyoxyethylene sorbitol esters of mixed fatty and resin acids, polyoxyethylene fatty acid, polyoxyethylene sorbitol oleate, polyoxyethylene sorbitan monostearate, polyoxyethylene sorbitol tallow esters, polyoxyethylene sorbitol tall oil, polyoxyethylene lauryl ether, polyoxyethylene sorbitan monooleate.

The aqueous phase is based on water, and may comprise some further ingredients, typically a polyelectrolyte such as a PAM.

The hydrophobic phase is not miscible with the aqueous phase. It is often referred to an oily phase. By “not miscible”, it is meant that the ingredient or mixture of ingredients of the hydrophobic phase is preferably not more than 10 weight % soluble in water, at a temperature comprised between 20° C. and the emulsion-preparation temperature or emulsion-use temperature.

Suitable hydrophobic phases include:
organic oils, vegetal oils, mineral oils, waxes, for example used in the field of cosmetics,
saturated or unsaturated fatty acids, saturated or unsaturated fatty acid esters, saturated or unsaturated fatty alcohols,
industrial lubricants or greases, for examples used to lubricate metal, to work metal, or recovered from metal degreasing,
vegetable oils, especially recycled vegetable oils
silicone oils,
diesel and kerosen cutbacks;
essential oils, and
agrochemical compounds.

The emulsion stabilized according the instant invention are advantageously inverse emulsions containing polyelectrolytes, e.g. PAM, in their aqueous dispersed phase. Depending on the exact nature of the polyelectrolytes present within such an emulsion (typically a PAM homo- and/or co-polymer of a given molecular weight and charge), the emulsion may be used for several applications, including notably the followings:
water treatment;
paper making;
explosives
oil extraction
mining
textile
when the polyelectrolytes present within the emulsion may e.g. act as flocculant; coagulants; thickening agent, superabsorbent, and/or soil conditioner.

The examples below illustrate a non-limiting embodiment of the invention and advantages relating to the compounds of formula (I).

### EXAMPLES

Several emulsion have been prepared, comprising, in weight % based on the total weight of the emulsion:
70% of an aqueous solution of NaCl 2M
28% of an oil (Hydroseal G232H); and
2% of one of the composition C1 to C3 described in the table 1 below, herein referred as “emulsifier compositions” and comprising an alkanolamide emulsifier and a copolymer (the amounts being the weight of active matter based on the total weight of the emulsion)

The emulsions differ from each other only by the nature of the emulsifier composition (C1 to C3 respectively). All the emulsions have been prepared in the same following conditions:
in each case, the considered emulsifier composition has first been mixed with the oil at 25° C.;
then, the aqueous solution of NaCl has been added to the resulting mixture;
an emulsification has been performed by stirring under Ultra Turrax at 13 500 rpm during 5 minutes after the addition of the aqueous solution of NaCl.

TABLE 1
the tested emulsifier compositions

| Composition | emulsifier | copolymer |
|---|---|---|
| C1 | 1.7% Mackamide WS 1 | Rhodibloc RS |
| C2 | 1.7% Mackamide MO | Rhodibloc RS |
| C3 | 1.7% Mackamide WS 1 | Dibloc copolymer |
| | | 2EHA-DMA* |

*DMA = N,N-Dimethylacrylamide

Each emulsion has been observed after the emulsification (at time t=0). No coalescence or flocs have been observed.

Besides, the evolution of the mean diameter D50 of the droplets of the emulsion and of the oil split ratio have been observed over storage at 25° C. The obtained the results are reported in tables 2 and 3 below.

TABLE 2
Evolution of D50

| | Composition used in the emulsion | | |
|---|---|---|---|
| Storage time | C1 | C2 | C3 |
| 0 | 0.4 μm | 0.3 μm | 0.5 μm |
| 1 month | 0.3 μm | 0.4 μm | 0.3 μm |
| 2 months | 0.4 μm | 0.4 μm | |
| 3 months | 0.4 μm | 0.4 μm | |
| 4 months | 0.4 μm | 0.3 μm | |
| 5 months | 0.3 μm | 0.3 μm | |
| 6 months | 0.4 μm | 0.4 μm | 0.3 μm |

TABLE 3
evolution of the oil split ratio

| | Composition used in the emulsion | | |
|---|---|---|---|
| Storage time | C1 | C2 | C3 |
| 0 | 0 | 0 | 0 |
| 1 month | 1 mm | 0.5 mm | 0 |
| 2 months | 2 mm | 2 mm | 1 mm |
| 3 months | 2 mm | 2 mm | 1 mm |
| 4 months | 2 mm | 2 mm | 1.5 mm |
| 5 months | 2 mm | 2 mm | 2 mm |
| 6 months | 2.5 mm | 3 mm | 2 mm |

1. A composition C comprising a mixture of:
at least an alkanolamide emulsifier; and
a block copolymer comprising:
a block A which is a hydrophilic block comprising units derived from mono-alpha-ethylenically-unsaturated monomers; and
a block B which is a hydrophobic block.

2. The composition of claim 1, wherein the ratio copolymer/alkanolamide corresponding to the quotient of the total mass of copolymer contained in composition C, to the total mass of the alkanolamide emulsifier contained in composition C is between 1% and 40%.

3. The composition of claim 1, wherein the alkanolamide emulsifier is a compound having the Formula (I) below:
R¹—C(═O)—N[—(R²O)ₓH)][—(R³O)_{y}H] (I)
wherein:
R¹ is an hydrocarbon chain bearing typically from 5 to 24 carbon atoms,
each of R² and R³, which are the same or not, is a hydrocarbon chain bearing from 2 to 4 carbon atoms,
each of x and y, which are the same or not, are of is between 1 and 5.

4. The composition of claim 3, wherein the alkanolamide emulsifier is a compound having the Formula (Ia) or (Ib) below:
R¹—C(═O)—N(R²OH)(R³OH) (Ia)
R¹—C(═O)—N(R²OH)₂ (Ib)
wherein R¹, R² and R³ are as defined in claim 3.

5. The composition of claim 1, wherein the block copolymer is a (block A)-(block B) di-block copolymer.

6. The composition of claim 1, wherein the block A of the block copolymer comprises repeating units deriving from N-vinyl pyrrolidone, acrylamide and/or N,N-Dimethylacrylamide.

7. The composition of claim 6 wherein the block A of the block copolymer comprises repeating units deriving from N-vinyl pyrrolidone and the block B of the block copolymer comprises repeating units deriving from 2-ethyl-hexyl acrylate.

8. An emulsion comprising a composition C according to claim 1.

9. The emulsion of claim 8, wherein it is an inverse emulsion containing PAM homo- or co-polymers in their dispersed aqueous phase.

10. The emulsion of claim 8, wherein the content of composition C is between 0.5% and 5%, in mass, based on the total mass of the emulsion containing the composition C.

11. The emulsion of claim 8, comprising from 1% to 2% of the alkanolamide emulsifier; and from 0.001% to 0.5% of the copolymer, in mass, based on the total mass of the emulsion containing the composition C.

12. A method, comprising stabilizing an emulsion using the composition C of claim 1.

13. The composition of claim 1, wherein block A is distinct from a block having a lower critical solubility temperature (LCST).

14. The composition of claim 1, wherein block B is derived from mono-alpha-ethylenically-unsaturated monomers.

15. The composition of claim 2, wherein the ratio copolymer/alkanolamide corresponding to the quotient of the total mass of copolymer contained in composition C, to the total mass of the alkanolamide emulsifier contained in composition C is between 2 and 20%.

16. The emulsion of claim 10, wherein the content of composition C is between 1% and 4% in mass, based on the total mass of the emulsion containing the composition C.

17. The method of claim 12, wherein the emulsion is an inverse emulsion.

18. The method of claim 17, wherein the inverse emulsion contains a PAM homo- or co-polymer in its dispersed aqueous phase.
